(19) United States
(12) Patent Application Publication
(10) Pub. No.: US 2020/0242564 A1
(43) Pub. Date: Jul. 30, 2020

(54) EMPLOYEE AND EMPLOYER MATCHING SYSTEM AND METHOD OF USE

(71) Applicant: Charles F. Causey, JR., Arlington, TX (US)

(72) Inventor: Charles F. Causey, JR., Arlington, TX (US)

(21) Appl. No.: 16/776,446

(22) Filed: Jan. 29, 2020

Related U.S. Application Data
(60) Provisional application No. 62/798,285, filed on Jan. 29, 2019.

(51) Int. Cl. G06Q 10/10; G06Q 10/06; G09B 7/02

(52) U.S. Cl. CPC G06Q 10/1053; G09B 7/02; G06Q 10/06398

(57) ABSTRACT

An employee and employer matching system allows for those seeking employment to determine their natural strengths by assessments or other test given by a portal. The results of the assessment are used to match the employee to a job opening listed by an employer. The employees and employer communicated through the portal.

### BACKGROUND

### 1. Field of the Invention

The present invention relates generally to human resource (HR) systems (especially those HR systems within the recruiting realm such as recruiting platforms, applicant tracking systems, hiring assessments, and job boards), and more specifically, to an employee and employer matching system that determines in whole or in part the natural strengths, skills (hard skills, soft skills, and/or knowledge), and values of a potential employee and matches the employee with a potential job based on these data points.

### 2. Description of Related Art

Human resource (HR) systems—especially those HR systems within the recruiting realm such as recruiting platforms, applicant tracking systems, hiring assessments, and job boards—hereafter referred to generally as “Human resource systems” are well known in the art as a means to help employers source and select suitable job candidates for their open positions, manage the recruiting workflow and related data, and help job seekers find employment opportunities.

One of the problems for employers commonly associated with these human resource systems is its limited effectiveness to source and identify of suitable candidates. It is commonly understood that these human resource systems help an employer obtain resumes and job applications, however any insight that will help the employer identify candidates who are likely to succeed in the job, beyond what is on the candidates resume is limited or non-existent. The problem is that the primary data point that these HR systems typically use to initially match candidates with an employer is the information found in a candidate's resume. This information is composed mainly of contact information, job interest, previous work experience, educational history, and keywords related to the candidate's perception of their own skills or objectives. Studies have shown that this information is a statistically poor predictor of on-the-job performance. This foundational problem—the fact that HR systems primarily rely on information from the candidate from their perspective to match candidates with employer roles—results in multiple downstream problems for both employers and candidates.

For example, problems that result from these HR systems include wasted time and money to source and sort through resumes, interview candidates who are not qualified, make hiring mistakes that result in lost productivity and turnover, and discrimination (from both conscious and unconscious bias based on the subjective sentiment related to filtering resumes).

It is also commonly understood that employers often require higher education levels than a job actually requires, but this is done primarily as a means to filter the resumes to a manageable number. Although this tactic sorts or filters resumes, it results in fewer opportunities for minority groups and the employer misses highly qualified candidates because they lack an unnecessary education credential.

For job seekers, it is commonly known that the job search and career change process is time consuming and difficult in spite of the existence of these human resource systems. Usually, a job seeker submits a resume to numerous jobs to receive a single interview request. Job seekers, commonly, only receive an interview request if their resume fits the role perfectly. This leaves many qualified job seekers unable to find a job that leverages their unique strengths and skills because the resume does not show the employer what the individual is capable of.

Accordingly, although great strides have been made in the area of human resource systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a diagram of an employee and employer matching system in accordance with a preferred embodiment of the present application;

FIG. 2 is a simplified schematic of the electronic environment of the system of FIG. 1;

FIG. 3 is a diagram of the system of FIG. 1 in use;

FIG. 4 is a diagram of the matching platform of FIG. 3; and

FIG. 5 is a flowchart of a method of matching an employer with and employee.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional human resource systems. Specifically, the present invention provides means of objectively and methodically evaluating employees and matching them with jobs that align with their strengths. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

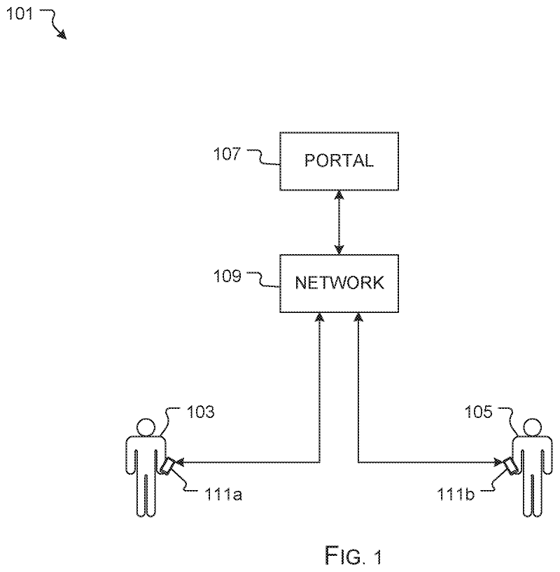

Referring now to the drawings wherein like reference characters identify corresponding or similar elements throughout the several views, FIG. 1 depicts a diagram of an employee and employer matching system in accordance with a preferred embodiment of the present application. It will be appreciated that system 101 overcomes one or more of the above-listed problems commonly associated with conventional human resource systems.

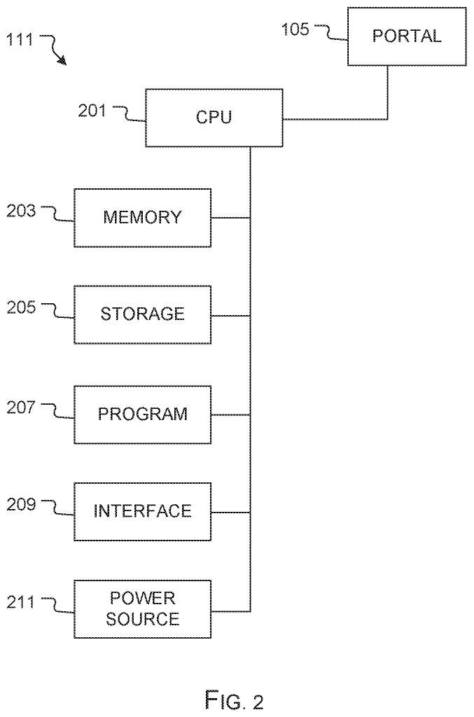

In the contemplated embodiment, system 101 includes an employer 103 with a job or job openings and an employee 105 in electronic communication with each other via portal 107 via network 109 and computing devices 111. The computing devices 111 in communication with the portal 107 create an electronic environment that facilitates the communication between the employer 103 and the employee 105. That environment is further depicted by FIG. 2. Where in the computing devices 111 include a CPU 201 operating in conjunction with memory 203, storage 205, programing 207, interface 209 and a power source 211, It is further contemplated that other components, hardware or software could contribute to the electronic environment.

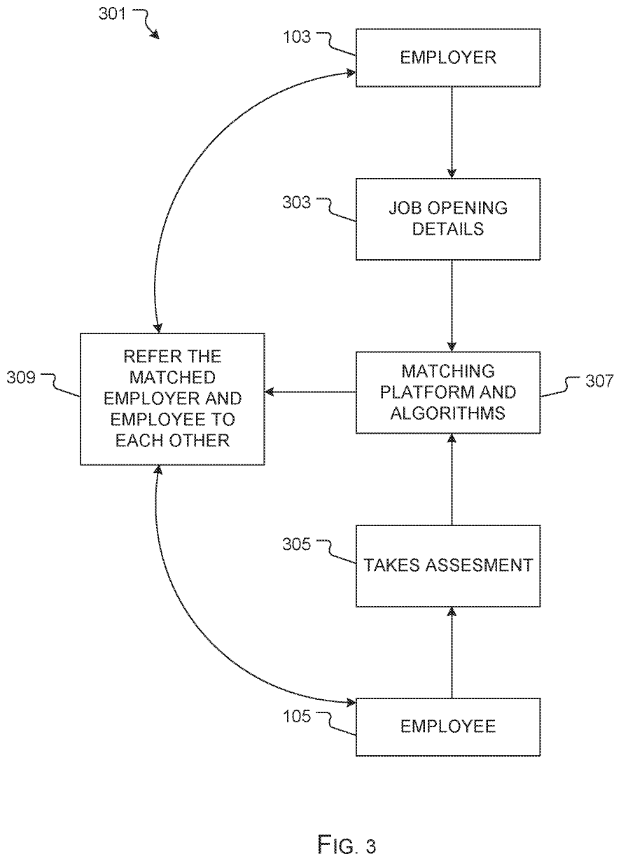

Referring now to FIG. 3 the interaction of the employer 103 and the employee 105 is depicted. Interaction 301 includes that the employer 105 provides job opening details 303 to the portal 107, the employee 105 uploads data and takes an assessment 305 via the portal. The portal 107 activating the matching platform or algorithms 307 to compare the job opening details with the results of the assessment and then the portal refers the matched employer and employee to each other 309 thereby a preferred match that reduces the number of resumes or applicants that must be submitted or reviewed to fulfill the open job listing is created.

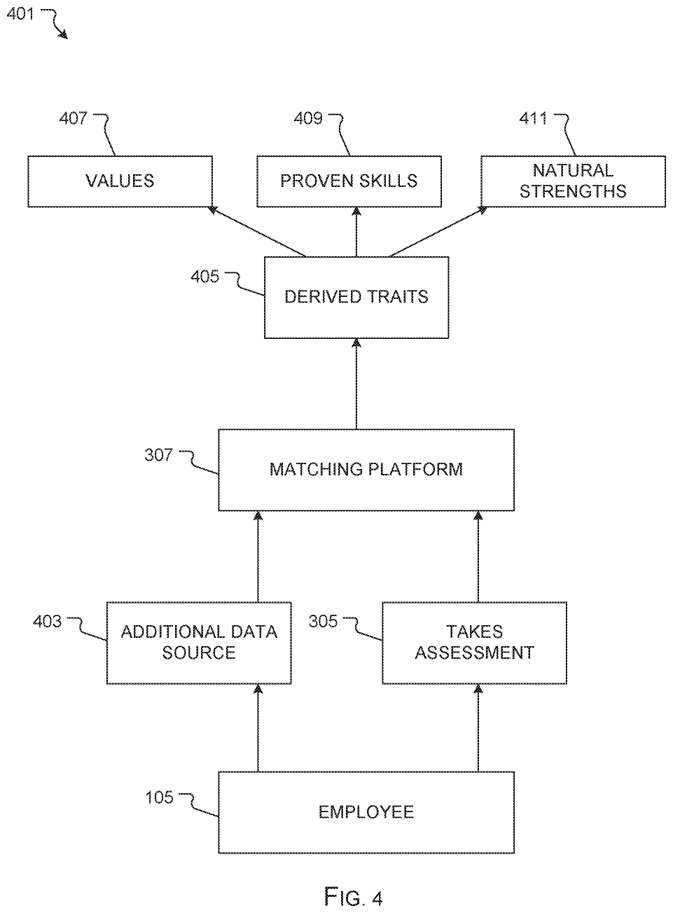

An embodiment of the matching platform 307 is further depicted by FIG. 4. The matching platform 307 has the employee 105 take the assessment 305 and also could require data from and additional data source 403 or secondary assessment. These are provided to the matching platform 307 wherein a set of derived traits 405 are created and cataloged. These derived traits 405 could include values 407, proven skills 409 and natural strengths 411. While these are provided others could be derived by the matching platform 307, It is contemplated that these derived traits 405 are used by the system 101 to match the employee 105 with employer 103.

It should be appreciated that one of the unique features believed characteristic of the present application is that portal 107 improves the matching of job openings of the employers 103 with employees 105 that possess natural or developed strengths related thereto via the assessments.

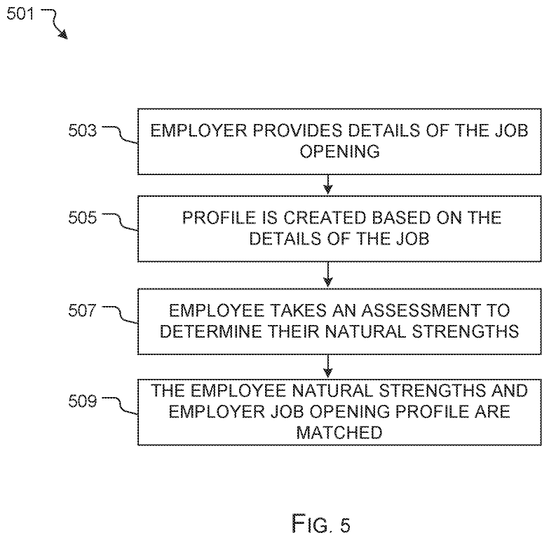

Referring now to FIG. 5 a method of matching potential employees with prospective employers is depicted. Method 501 includes the employer providing details of the job opening to the portal 503, creating a profile based on the details of the job 505, the employee taking an assessment to determine their natural strengths 507 and the strengths of the employee being matched with the profile of the job opening 509.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. An employee and employer matching system, comprising:
an electronic environment created between at least one computing device in electronic communication with a portal via a network;
at least one employer with at least one job opening; and
at least one employee;
wherein in the portal in the electronic environment improves the communication between the employer and the employee; and
wherein details of the job are matched with the results of an assessment of the employee to offer a job to the at least one employees.

2. An employee and employer matching system, comprising:
a portal configured to evaluate potential employees by assessments given thereto with job opening listed by employers that results in a set of derived traits.

3. The system of claim 2 wherein the derived traits include natural strengths, values and proven skills.

4. A method of matching potential employees with prospective employers, comprising:
the employer providing details of the job opening to the portal;
creating a profile based on the details of the job;
the employee taking an assessment to determine their natural strengths; and
the strengths of the employee being matched with the profile of the job opening.
